(19) United States
(12) Patent Application Publication
(10) Pub. No.: US 2026/0284884 A1
(43) Pub. Date: Sep. 24, 2026

(54) ROBOT SETTING DEVICE

(71) Applicant: FANUC CORPORATION, Minamitsuru-gun, Yamanashi (JP)

(72) Inventor: Norio TAKEI, Yamanashi (JP)

(21) Appl. No.: 19/471,891

(22) PCT Filed: Apr. 21, 2023
(86) PCT No.: PCT/JP2023/016004

§ 371 Date: Oct. 2, 2025

(51) Int. Cl. B25J 9/16

(52) U.S. Cl. CPC B25J 9/1671

(57) ABSTRACT

A robot setting device comprises: a recording processing unit for calculating and recording a cycle time and power consumption of a robot on the basis of an operation history of the robot operated by a servo motor; and a setting determination unit for executing a simulation based on a setting by which a waiting time is reduced, the waiting time being a duration of time from a servo-on waiting state to servo-off where a control state of the servo motor in the operation history is cancelled, the servo-on waiting state being said control state. The setting determination unit determines, by repeating the simulation while changing the waiting time up to the servo-off state such that the cycle time on the simulation satisfies a predetermined criterion, a setting condition of the robot by which a reduction in power consumption can be achieved.

### TECHNICAL FIELD

The present disclosure relates to a robot setting device.

### BACKGROUND ART

Conventionally, robot control has been carried out with consideration given to a balance between operating time, such as cycle time, and power consumption. An example of a document disclosing this type of technology is Patent Document 1.

Patent Document 1 relates to a power consumption monitor for an industrial robot. Patent Document 1 shows that the power consumption of the industrial robot is stored for every step of a work program, and a notification is made of the stored power consumption, thereby correcting the work program while striking a balance between the takt time and the power consumption.

### CITATION LIST

### Patent Document

Patent Document 1: Japanese Unexamined Patent Application, Publication No. 2013-063475

### DISCLOSURE OF THE INVENTION

### Problems to be Solved by the Invention

A servomotor that drives a robot may be in an energized state even with the robot in a wait state, and may thus consume unnecessary power. When a specified time has elapsed since the robot enters into the wait state, a known robot controller turns the motor off to reduce the power consumption.

Unfortunately, in a known technology, once the servomotor is turned off, the servomotor needs to be again energized and to release its brake. Thus, such a brake releasing process takes time. This may affect the cycle time. It is not easy to perform appropriate setting that reduces the influence on the cycle time while lowering the power consumption. Additionally, since an interlock with other robots and peripheral devices in a factory is a mechanism that is not released unless a predetermined condition is satisfied, there is also the problem that change settings is difficult.

The present disclosure has been made in view of the problem, and an object of the present disclosure is to provide a technology that enables setting of a robot setpoint achieving an appropriate balance between cycle time and power consumption.

### Means for Solving the Problems

The present disclosure is directed to a robot setting device including: a recording processor configured to calculate a cycle time and a power consumption of a robot operated by a servomotor based on an operational history of the robot and to record the cycle time and power consumption; and a setting determination unit configured to execute a simulation based on a setting that shortens a wait time during which a shift is made from a wait state in a servo-on mode to a servo-off mode in the operational history, the wait state being a state where the servomotor is controlled, the servo-off mode being a mode in which the state where the servomotor is controlled is released. The setting determination unit repeats the simulation while changing the wait time during which the shift is made to the servo-off mode so that the cycle time in the simulation satisfies a predetermined reference, thereby determining a set condition of the robot that reduces an amount of power consumption.

### Effects of the Invention

According to the present disclosure, a technology that enables setting of a robot setpoint achieving an appropriate balance between the cycle time and the power consumption can be provided.

### BRIEF DESCRIPTION OF THE DRAWINGS

FIG. 1 is a schematic diagram showing a configuration of a robot system including a robot setting device according to a first embodiment;

FIG. 2 is a block diagram showing the robot system according to the embodiment;

FIG. 3 is a flowchart showing an exemplary flow of a setting process to be performed by the robot setting device;

FIG. 4 is a table showing an exemplary flow of an operational history of a robot;

FIG. 5 is a table showing an exemplary execution program included in the operational history of the robot; and

FIG. 6 is a schematic diagram showing a configuration of a robot system including a robot setting device according to a second embodiment.

### PREFERRED MODE FOR CARRYING OUT THE INVENTION

Embodiments of the present disclosure will be described in detail below with reference to the drawings. In the description of a second embodiment and the following embodiments, like reference numerals denote components common to those in the first embodiment, and the description thereof is omitted as appropriate.

### First Embodiment

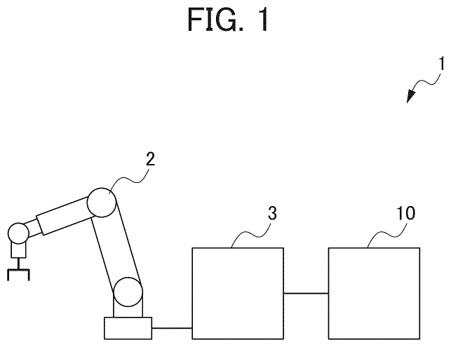

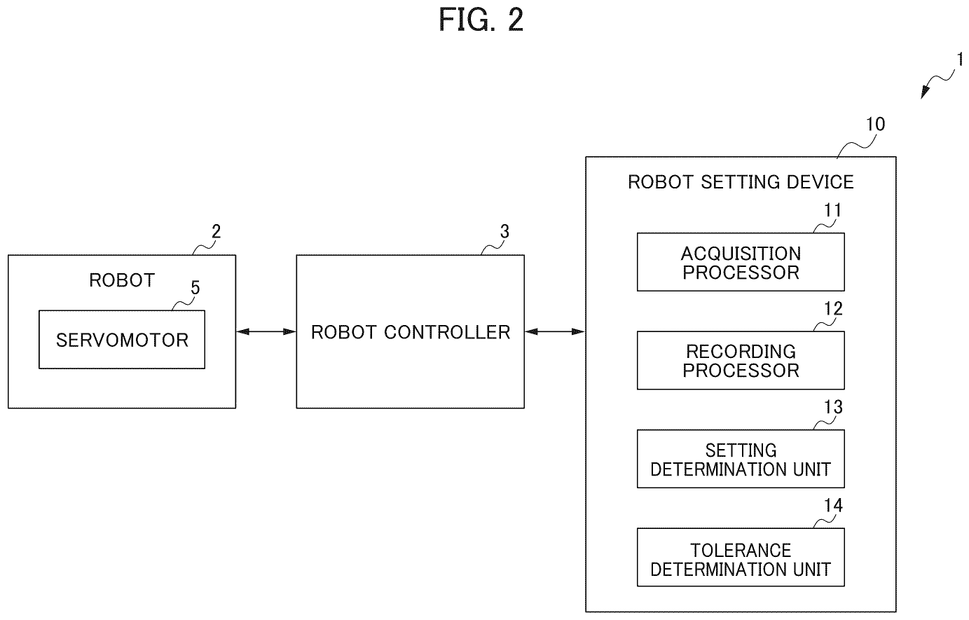

FIG. 1 is a schematic diagram showing a configuration of a robot system 1 including a robot setting device 10 according to a first embodiment. FIG. 2 is a block diagram showing the robot setting device 10 according to this embodiment.

As shown in FIG. 1, the robot system 1 includes a robot 2, a robot controller 3, and the robot setting device 10.

The robot 2 is, for example, an articulated robot, such as a six-axis vertical articulated robot or a four-axis vertical articulated robot, and is operated by a servomotor 5. The robot 2 is electrically connected to the robot controller 3, and the servomotor 5 is controlled based on information received from the robot controller 3. The robot 2 should not be limited to an articulated robot, and may be a Cartesian coordinate robot, a selective compliance assembly robot arm (SCARA) robot, a parallel link robot, or any other suitable robot.

The robot controller 3 is an information processor that controls operations of the robot 2 based on a program set up. The robot controller 3 is configured using a computer including a memory, such as a read only memory (ROM) or a random access memory (RAM), a central processing unit (CPU), and a communication controller connected together via a bus, for example. The robot controller 3 may be a numerical controller that performs machining control, or may be a computer for creating a program independent of a machine tool.

The robot setting device 10 is a server that performs various types of setting of the robot controller 3 to control operations of the robot 2. The robot setting device 10 is also an information processor configured using a computer including a memory, such as a ROM or a RAM, a CPU, and a communication controller connected together via a bus, for example.

As shown in FIG. 2, the robot setting device 10 includes an acquisition processor 11, a recording processor 12, a setting determination unit 13, and a tolerance determination unit 14 as functional components that operate on the CPU. The function and operation of each of functional components of the robot setting device 10 are achieved through cooperation of the CPU, the memory, and a control program stored in the memory.

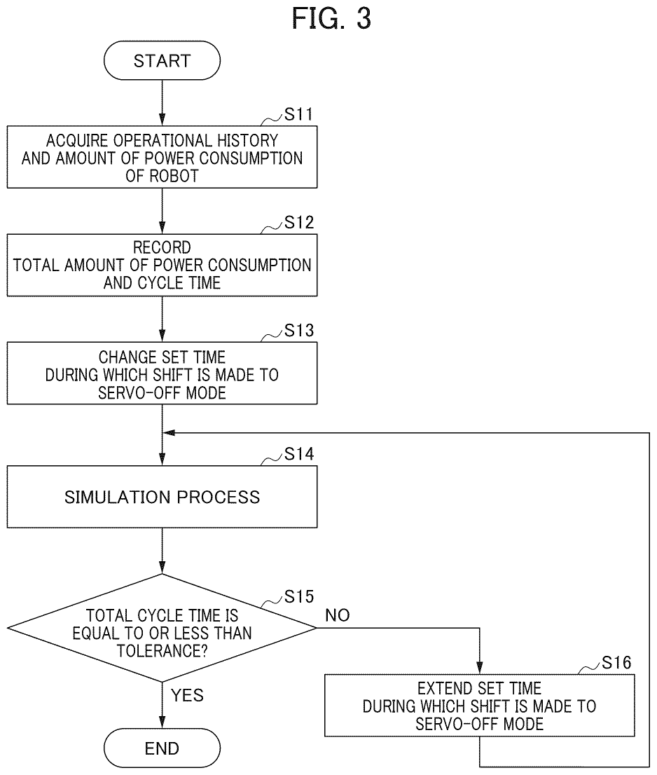

The functional components that operate on the CPU of the robot setting device 10 will be described with reference to FIG. 3. FIG. 3 is a flowchart showing an exemplary flow of a setting process to be performed by the robot setting device 10. The flowchart shown in FIG. 3 is merely an example, and the sequence and content of processes can be changed as appropriate.

First, the acquisition processor 11 acquires an operational history indicating operations of the robot 2, and the amount of power consumption corresponding to each of the operations (Step S11). For example, the acquisition processor 11 monitors the operations of the robot 2, and acquires the operational history and the amount of power consumption based on information transmitted from the robot controller 3 or the robot 2. The amount of power consumption may be previously calculated by the robot controller 3 or by the robot 2, or may be calculated based on information indicating the amount of electric power acquired from the robot controller 3 or from the robot 2 by the acquisition processor 11.

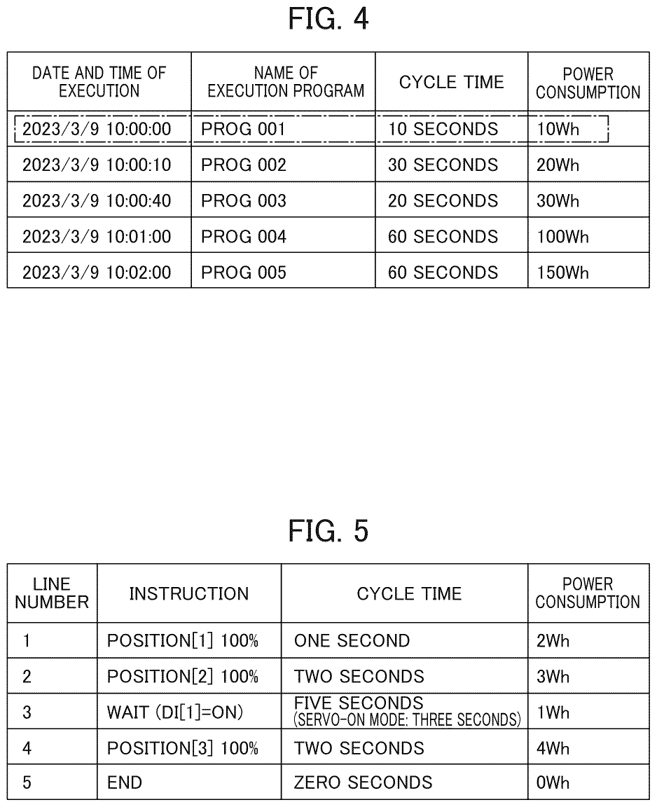

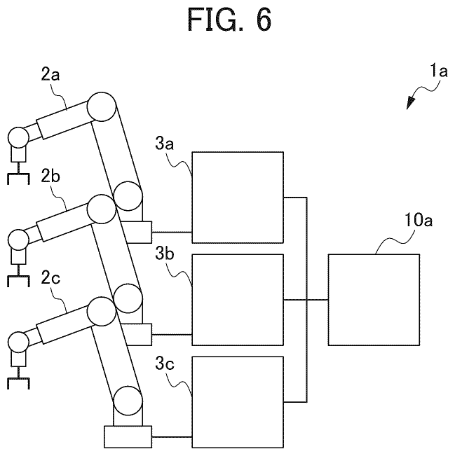

The information acquired by the acquisition processor 11 will be described here with reference to FIGS. 4 and 5. FIG. 4 is a table showing an exemplary flow of the operational history of the robot 2. FIG. 5 is a table showing an exemplary execution program included in the operational history of the robot 2.

FIG. 4 shows the dates and times of execution, the names of execution programs, cycle times, and power consumptions as an exemplary operational history. The dates and times of execution are information indicating the start time at which the robot 2 is actually brought into operation by the robot controller 3. The names of execution programs each indicate a program executed at the date and time indicated by the corresponding date and time of execution. The program “PROG 001” is, for example, an execution program indicating an operation in which the robot 2 moves to its home position.

The programs “PROG 002” to “PROG 005” are, for example, execution programs indicating various operations of the robot 2, such as replacement of parts and gripping of parts. Both the cycle times and the power consumptions are values on an execution program-by-execution program basis. The cycle times and the power consumptions may be calculated values or actual values.

In the example in FIG. 4, the cycle time of the program “PROG 001” executed at ten o'clock on Mar. 9, 2023 is 10 seconds, and the power consumption thereof is 10 Wh. The execution program shown in FIG. 5 corresponds to the program “PROG 001” in the table of FIG. 4.

FIG. 5 shows line numbers, instructions, cycle times, and the power consumptions as an exemplary execution program included in the operational history. The line numbers are information for referring to lines of the program. The instructions describe what the robot 2 is instructed to do. Both the cycle times and the power consumptions are values on an instruction-by-instruction basis. The cycle times and the power consumptions may be calculated values or actual values.

In the example in FIG. 5, the instructions each describe “POSITION” specifying a position or “WAIT” indicating a wait state in a servo-on mode. The description “DI[1]=ON” described to the right of “WAIT” indicating the wait state indicates an external ready signal. The time “FIVE SECONDS” indicated by the cycle time indicates that a DI signal (a digital signal input to the robot system 1) is received in five seconds.

The description “SERVO ON THREE SECONDS” indicates the time during which a shift is made from the wait state in the serve-on mode to a servo-off mode. In this embodiment, the time during which a shift is made to the servo-off mode is a value previously set in the form of a parameter not in the program but in the robot setting device 10, the robot controller 3, the robot 2, or any other device. The time should not be limited to that in this embodiment, and the time during which a shift is made to the servo-off mode may be configured to be specified in the program.

The exemplary operational history and the exemplary power consumption have been described above. Returning to the flowchart in FIG. 3, processes in and after Step S12 will be described.

After the process in Step S11, the recording processor 12 calculates the total amount of power consumption and the total cycle time based on the operational history acquired by the acquisition processor 11 and the amount of power consumption corresponding to each operation, and records the calculated total amount of power consumption and the calculated total cycle time (Step S12). For example, the recording processor 12 adds up the cycle times acquired from the operational history on an execution program-by-execution program basis to calculate the total cycle time, and adds up the amounts of power consumption on the execution program-by-execution program basis to calculate the total power consumption. In a case in which information received from the robot controller 3 or from the robot 2 indicates the cycle times or the power consumptions in the execution program shown in the table of FIG. 5, the cycle times or the power consumptions may be added up to calculate the cycle time or the power consumption on the execution program-by-execution program basis.

The recording processor 12 stores the calculated total cycle time and the calculated total amount of power consumption in a storage unit configured as a memory or any other similar component. After the process in Step S12, the process proceeds to Step S13.

Next, the setting determination unit 13 determines a part of the operational history where the robot 2 waits in the servo-on mode, and changes, and shortens, the set time during which a shift is made to the servo-off mode and which is previously set in this part to zero (Step S13). First, a determining process will be described. In the examples shown in FIGS. 4 and 5, a part describing “WAIT” is determined to be the part where the robot 2 waits in the servo-on mode. In this example, the part where the robot 2 waits in the servo-on mode is included only in the execution program “PROG 001.” Alternatively, any one of the programs “PROG 002” to “PROG 005” may describe “WAIT” indicating the part where the robot 2 waits in the servo-on mode.

After the process of determining the part where the robot 2 waits in the servo-on mode, the setting determination unit 13 executes the process of shortening the wait time. In this process, the set time during which a shift is made to the servo-off mode is changed from three seconds to zero seconds.

Changing the set time during which a shift is made to the servo-off mode to zero shortens the operating time of the servomotor. This can be expected to reduce the power consumption. After the process in Step S13, the process proceeds to Step ST14.

Next, the setting determination unit 13 performs a simulation process based on the changed set time to acquire the total cycle time (Step S14). In this example, the total cycle time is calculated on condition that the set time during which a shift is made to the servo-off mode be zero.

In a case in which the set time during which a shift is made to the servo-off mode is set to be zero, switching is made from the servo-on mode to the servo-off mode, resulting in a significant reduction in the amount of power consumption. Unfortunately, the robot entering into the servo-off mode causes its brake to be applied in order to prevent the robot axes from falling. Thus, time is required to release the brake. Occurrence of the servo-off mode may increase the cycle time.

To address this problem, after the process in Step S14, the tolerance determination unit 14 determines whether or not the total cycle time acquired as a result of the simulation is equal to or less than a previously set tolerance (Step S15).

For example, the tolerance is a value previously set by the robot 2, the robot controller 3, or any other device. The tolerance is a criterion for maintaining the total cycle time at a reference.

In Step S15, in a case in which the tolerance determination unit 14 determines that the total cycle time is equal to or less than the tolerance, the tolerance determination unit 14 adopts the set time at the time of calculation of the total cycle time to be determined, as the wait time during which a shift is made to the servo-off mode and which is for use in actual control (a parameter), and ends a series of processes (Step S15; YES).

In Step S15, in a case in which the tolerance determination unit 14 determines that the total cycle time is not equal to or less than the tolerance, the process proceeds to Step S16 (Step S15; NO).

In Step S16, if the process proceeds to the subsequent process with the servo-on mode maintained without performing the process of releasing the brake, the setting determination unit 13 can shorten the cycle time. Thus, the process of extension of the set time adopted in the simulation is executed. For example, the set time is changed from zero seconds to one second. This increases the set time during which a shift is made to the servo-off mode in the simulation.

In Step S16, in a case in which a plurality of parts where the robot 2 waits in the servo-on mode are present, the setting determination unit 13 executes the process of extension from the part where the value of the set time is smaller.

After the process in Step S16, the setting determination unit 13 allows the process to proceed to Step S14, and performs a simulation process based on the set time after the process of extension (e.g., one second) to calculate the total cycle time. The processes in Steps S14 to S16 are repeated until the total cycle time becomes equal to or less than the tolerance.

While the processes in Steps S14 to S16 are repeated, the process of extension in Step S16 is repeated. As a result, the set time increases gradually, and the process of extension ends at the point in time when the cycle time becomes equal to or less than the tolerance. The setting determination unit 13 sets the set time at the time when the cycle time becomes equal to or less than the tolerance to be a parameter for the wait time during which a shift is made to the servo-off mode.

The process of determining whether or not the total power consumption has been reduced may be incorporated during the processes in Steps S14 to S16. Shortening the set time during which a shift is made to the servo-off mode can reduce the power consumption. Meanwhile, adding the process of determining whether or not the power consumption has been reduced can more reliably achieve an appropriate balance between the cycle time and a reduction in the power consumption.

The robot setting device 10 of this embodiment described above provides the following advantages. The robot setting device 10 includes the recording processor 12 configured to calculate the cycle time and power consumption of the robot 2 based on the operational history of the robot 2 operated by the servomotor 5 and to record the calculated cycle time and power consumption, and the setting determination unit 13 configured to execute a simulation based on a setting that shortens the wait time (set time) during which a shift is made from the wait state in the servo-on mode to the servo-off mode in the operational history. In the wait state, the servomotor 5 is controlled. In the servo-off mode, the controlled state is released. The setting determination unit 13 repeats the simulation while changing the wait time during which a shift is made to the servo-off mode so that the cycle time in the simulation satisfies a predetermined reference (equal to or less than the tolerance), thereby determining the set condition of the robot 2 that can reduce the amount of power consumption.

This can shorten the wait time during which a shift is made from the wait state in the servo-on mode to the servo-off mode, and can reduce the power consumption. In addition, operating noise produced while the servomotor is on can be reduced, leading to an effective reduction in noise. Furthermore, repeating the simulation so that the cycle time satisfies the predetermined reference optimizes the setpoint of the robot 2 to be a value that can achieve an appropriate balance between the cycle time and the amount of power consumption.

The setting determination unit 13 of this embodiment sets the wait time during which a shift is made from the wait state in the servo-on mode to the servo-off mode to be the set condition of the robot 2.

In this manner, the wait time during which a shift is made to the servo-off mode and which has been optimized to be a value that can achieve an appropriate balance between the cycle time and the amount of power consumption is set to be a set condition, thereby achieving efficient operation of the robot 2.

The setting determination unit 13 of this embodiment specifies a command indicating the wait state in the servo-on mode in the execution program that designates operations of the robot 2 acquired as the operational history, and shortens the wait time during which a shift is made from the wait state in the servo-on mode indicated by the command to the servo-off mode, thereby setting the set condition.

Thus, specifying the command indicating the wait state in the servo-on mode in the execution program enables reliable detection of the point at which the wait time during which a shift is made to the servo-off mode is shortened.

The robot setting device 10 of this embodiment further includes the tolerance determination unit 14 configured to, in a case in which the cycle time in the simulation is equal to or less than the previously set tolerance of the cycle time, determine that the cycle time satisfies the fixed reference.

In a case in which the tolerance determination unit 14 determines that the cycle time does not satisfy the fixed reference, the setting determination unit 13 performs the process of extension of the shortened wait time during which a shift is made to the servo-off mode, and then executes the simulation.

Thus, if the wait time is first minimized, and the amount of time to be extended in one process is set to be small, the cycle time can be set to be an optimum value that can significantly reduce the power consumption without extending the cycle time.

### Second Embodiment

The exemplary robot setting device 10 of the first embodiment has been described above. However, the present disclosure should not be limited to this configuration. Next, a robot system 1a including a robot setting device 10a of a second embodiment will be described.

The robot system 1a of the second embodiment includes a plurality of robots 2a to 2c, a plurality of robot controllers 3a to 3c, and a robot setting device 10a. The robot system 1a allows the plurality of robots 2a to 2c to cooperate to perform a predetermined task.

The plurality of robots 2a to 2c have a configuration similar to that of the robot 2 of the first embodiment. The robot controllers 3a, 3b, and 3c control the robot 2a, 2b, and 2c, respectively. The plurality of robot controllers 3a to 3c have a configuration similar to that of the robot controller 3 of the first embodiment.

The robot setting device 10a is connected to the plurality of robot controllers 3a to 3c to set the robots 2a to 2c as a whole. A process performed by the robot setting device 10a to set the set time is similar to that in the foregoing embodiment. For example, in a case in which a plurality of parts where the robots 2a to 2c wait in the servo-on mode are present, the setting determination unit 13 can execute the process of extension from the part where the value of the set time is smaller.

As described above, in the second embodiment, the recording processor 12 calculates the cycle time and power consumption of each of the plurality of robots 2a to 2c based on the operational history acquired from the corresponding one of the robots 2a to 2c, and records the calculated cycle time and power consumption. The setting determination unit 13 sets the set condition based on the simulation for each of the plurality of robots 2a to 2c.

As can be seen, also in a case in which the plurality of robots 2a to 2c cooperate to perform a task, repeating the simulation so that the cycle time satisfies the predetermined reference optimizes the setpoint for each of the robots 2a to 2c to be a value that can achieve an appropriate balance between the cycle time and the amount of power consumption.

While the present disclosure has been described in detail, the present disclosure should not be limited to the individual embodiments described above. Various additions, replacements, changes, partial deletions, and the like can be made to the embodiments without departing from the gist of the disclosure or without departing from the idea and the meaning of the present disclosure derived from the content described in the claims and equivalents of the claims. These embodiments can be implemented in combination. While, in the foregoing embodiments, the order of operations and the order of processes are illustrated as examples, the orders should not be limited to those described above. The same statement applies to a case where the description of the foregoing embodiments includes numeric values or formulae.

The following additional remarks given to the embodiments and variations are further disclosed.

### Additional Remark 1

A robot setting device (10, 10a) includes: a recording processor (12) configured to calculate a cycle time and a power consumption of a robot (2, 2a to 2c) operated by a servomotor (5) based on an operational history of the robot (2, 2a to 2c) and to record the cycle time and power consumption; and a setting determination unit (13) configured to execute a simulation based on a setting that shortens a wait time during which a shift is made from a wait state in a servo-on mode to a servo-off mode in the operational history, the wait state being a state where the servomotor (5) is controlled, the servo-off mode being a mode in which the state where the servomotor (5) is controlled is released. The setting determination unit (13)
repeats the simulation while changing the wait time during which the shift is made to the servo-off mode so that the cycle time in the simulation satisfies a predetermined reference, thereby determining a set condition of the robot that reduces an amount of power consumption.

### Additional Remark 2

In the robot setting device (10, 10a),
   the setting determination unit (13)
   sets the wait time during which the shift is made from the wait state in the servo-on mode to the servo-off mode to be the set condition of the robot (2, 2a to 2c).

### Additional Remark 3

In the robot setting device (10, 10a),
   the setting determination unit (13)
   specifies a command indicating the wait state in the servo-on mode in an execution program that designates an operation of the robot (2, 2a to 2c) acquired as the operational history, and shortens the wait time during which the shift is made from the wait state in the servo-on mode indicated by the command to the servo-off mode, thereby setting the set condition of the robot.

### Additional Remark 4

The robot setting device (10, 10a) further includes: a tolerance determination unit (14) configured to, in a case in which the cycle time in the simulation is equal to or less than a previously set tolerance of the cycle time, determine that the cycle time satisfies a fixed reference. In a case in which the tolerance determination unit (14) determines that the cycle time does not satisfy the fixed reference, the setting determination unit (13) performs a process of extension of the shortened wait time during which the shift is made to the servo-off mode, and executes the simulation.

### Additional Remark 5

In the robot setting device (10, 10a),
   the robot comprises a plurality of robots (2a to 2c), the recording processor (12) calculates the cycle time and power consumption of each of the robots (2a to 2c) based on the operational history acquired from the robot (2a to 2c), and records the cycle time and power consumption, and the setting determination unit (13)
   sets the set condition of each of the robots (2a to 2c) based

### EXPLANATION OF REFERENCE NUMERALS

2, 2a to 2c Robot
5 Servomotor
10, 10a Robot Setting Device
11 Acquisition Processor
12 Recording Processor
13 Setting Determination Unit
14 Tolerance Determination Unit

1. A robot setting device comprising:
a recording processor configured to calculate a cycle time and a power consumption of a robot operated by a servomotor based on an operational history of the robot and to record the cycle time and power consumption; and
a setting determination unit configured to execute a simulation based on a setting that shortens a wait time during which a shift is made from a wait state in a servo-on mode to a servo-off mode in the operational history, the wait state being a state where the servomotor is controlled, the servo-off mode being a mode in which the state where the servomotor is controlled is released,
the setting determination unit repeating the simulation while changing the wait time during which the shift is made to the servo-off mode so that the cycle time in the simulation satisfies a predetermined reference, thereby determining a set condition of the robot that reduces an amount of power consumption.

2. The robot setting device of claim 1, wherein
the setting determination unit sets the wait time during which the shift is made from the wait state in the servo-on mode to the servo-off mode to be the set condition of the robot.

3. The robot setting device according to claim 2, wherein
the setting determination unit specifies a command indicating the wait state in the servo-on mode in an execution program that designates an operation of the robot acquired as the operational history, and shortens the wait time during which the shift is made from the wait state in the servo-on mode indicated by the command to the servo-off mode, thereby setting the set condition of the robot.

4. The robot setting device according to claim 2, the device further comprising:
a tolerance determination unit configured to, in a case in which the cycle time in the simulation is equal to or less than a previously set tolerance of the cycle time, determine that the cycle time satisfies a fixed reference, wherein
in a case in which the tolerance determination unit determines that the cycle time does not satisfy the fixed reference, the setting determination unit performs a process of extension of the shortened wait time during which the shift is made to the servo-off mode, and executes the simulation.

5. The robot setting device according to claim 1, wherein
the robot comprises a plurality of robots, the recording processor calculates the cycle time and power consumption of each of the robots based on the operational history acquired from the robot, and records the cycle time and power consumption, and
the setting determination unit sets the set condition of each of the robots based on the simulation.

6. The robot setting device according to claim 3, the device further comprising:
a tolerance determination unit configured to, in a case in which the cycle time in the simulation is equal to or less than a previously set tolerance of the cycle time, determine that the cycle time satisfies a fixed reference, wherein
in a case in which the tolerance determination unit determines that the cycle time does not satisfy the fixed reference, the setting determination unit performs a process of extension of the shortened wait time during which the shift is made to the servo-off mode, and executes the simulation.

7. The robot setting device according to claim 2, wherein
the robot comprises a plurality of robots, the recording processor calculates the cycle time and power consumption of each of the robots based on the operational history acquired from the robot, and records the cycle time and power consumption, and
the setting determination unit sets the set condition of each of the robots based on the simulation.

8. The robot setting device according to claim 3, wherein
the robot comprises a plurality of robots, the recording processor calculates the cycle time and power consumption of each of the robots based on the operational history acquired from the robot, and records the cycle time and power consumption, and
the setting determination unit sets the set condition of each of the robots based on the simulation.

9. The robot setting device according to claim 4, wherein
the robot comprises a plurality of robots, the recording processor calculates the cycle time and power consumption of each of the robots based on the operational history acquired from the robot, and records the cycle time and power consumption, and
the setting determination unit sets the set condition of each of the robots based on the simulation.

10. The robot setting device according to claim 6, wherein
the robot comprises a plurality of robots, the recording processor calculates the cycle time and power consumption of each of the robots based on the operational history acquired from the robot, and records the cycle time and power consumption, and
the setting determination unit sets the set condition of each of the robots based on the simulation.
